(19) United States
(12) Patent Application Publication
(10) Pub. No.: US 2014/0027049 A1
(43) Pub. Date: Jan. 30, 2014

(54) CHIP EJECTOR AND CHIP REMOVAL METHOD USING THE SAME

(71) Applicants: Yong Hui JOO, Suwon (KR); Sung Keun PARK, Suwon (KR); Kyung Sun JWA, Suwon (KR); Jung Mi OH, Suwon (KR); Bum Sik JANG, Suwon (KR)

(72) Inventors: Yong Hui JOO, Suwon (KR); Sung Keun PARK, Suwon (KR); Kyung Sun JWA, Suwon (KR); Jung Mi OH, Suwon (KR); Bum Sik JANG, Suwon (KR)

(73) Assignee: SAMSUNG ELECTRO-MECHANICS CO., LTD., Suwon (KR)

(21) Appl. No.: 13/616,836

(22) Filed: Sep. 14, 2012

(30) Foreign Application Priority Data
Jul. 25, 2012 (KR) 10-2012-0081465

(51) Int. Cl. B32B 38/10

(52) U.S. Cl. 156/247; 156/538

(57) ABSTRACT

There is provided a chip ejector including a fixing unit; and at least one or more conveying units disposed outwardly of the fixing unit, wherein the conveying units fall with a tape having one surface attached to upper portions of the conveying units, and separate a chip attached to the other surface of the tape therefrom.

### CROSS-REFERENCE TO RELATED APPLICATIONS

This application claims the priority of Korean Patent Application No. 10-2012-0081465 filed on Jul. 25, 2012, in the Korean Intellectual Property Office, the disclosure of which is incorporated herein by reference.

### BACKGROUND OF THE INVENTION

1. Field of the Invention

The present invention relates to a chip ejector, and more particularly, to a chip ejector for separating a chip from a tape and a chip removal method thereof.

2. Description of the Related Art

In order to realize high density component mounting in a semiconductor device, a stack package in which a plurality of semiconductor chips are mounted on a wiring substrate in a 3 dimensional manner has recently been commercialized. In this case, the thickness of a semiconductor chip may be several tens of μm or less.

To mount such a thin semiconductor chip on a wiring substrate, a tape for protecting an integrated circuit is bonded to a circumferential surface of a semiconductor wafer in which the integrated circuit is formed, a rear side of the semiconductor wafer is polished and etched in this state, and thus the thickness thereof is significantly reduced at a level of several tens of μm.

Such a thin semiconductor wafer, the rear side of which is bonded to a bonding tape, is diced so that the semiconductor wafer is separated into a plurality of individual chips.

Thereafter, a rear side of the bonding tape is rolled by using a pin and the like so that the semiconductor chips may be detached from the bonding tape one after another.

The semiconductor chip removed from the bonding tape is mounted on the wiring substrate.

However, during a process of assembling a package using such a thin chip, cracks or defects may easily occur in a chip when individual chips split by dicing are removed and picked up from the bonding tape, and thus, research into a method of preventing the occurrence of cracks or defects is urgently required.

Patent Document 1, in the related art, discloses a device for removing a semiconductor chip using a pin.

However, pressure may be concentrated on a small area of a semiconductor chip due to a collision between the semiconductor chip and the pin, and a thickness of the semiconductor chip may be reduced due to high integration of the semiconductor chip, which may cause cracks in the semiconductor chip due to an impact between the semiconductor chip and the pin.

### RELATED ART DOCUMENT

(Patent Document 1) U.S. Patent Publication No. 20040105750

### SUMMARY OF THE INVENTION

An aspect of the present invention provides a chip ejector and a chip removal method capable of suppressing damage to a chip such as cracks and breakdowns, thereby preventing wasted manufacturing costs due to defective chips and separating the chip from a tape stably.

According to an aspect of the present invention, there is provided a chip ejector including: a fixing unit; and at least one or more conveying units disposed outwardly of the fixing unit, wherein the conveying units fall with a tape having one surface attached to upper portions of the conveying units, and separate a chip attached to the other surface of the tape therefrom.

The individual conveying units may fall sequentially.

The individual conveying units may sequentially fall inwardly from the outside thereof.

The individual conveying units may sequentially fall outwardly from the inside thereof.

The fixing unit and the conveying units may have a through hole that passes through an upper side and a lower side thereof.

The through hole formed in the fixing unit may have at least one pin installed therein.

Air may be drawn through the through hole such that the tape is adhered and fixed to the conveying units.

The chip ejector may further include a pickup unit picking up the chip separated from the tape.

The chip ejector may further include a conveying unit actuator transferring power to the conveying units.

According to another aspect of the present invention, there is provided a chip removal method including: mounting a tape to which a chip is attached on one surface of a fixing unit and one surface of at least one or more conveying units disposed outwardly of the fixing unit; adhering and fixing the tape to one surface of the fixing unit and one surface of the conveying units by drawing air through holes formed in the fixing unit and the conveying units; and controlling the individual conveying units to fall sequentially.

The individual conveying units may sequentially fall inwardly from the outside thereof.

The individual conveying units may sequentially fall outwardly from the inside thereof.

The chip removal method may further include pushing the tape to which the chip is attached upwards by raising a pin installed in the through hole formed in the fixing unit such that the pin protrudes outwardly from the fixing unit.

The chip removal method may further include pushing the tape to which the chip is attached upwards by spraying air through the through hole formed in the fixing unit.

The chip removal method may further include adhering and fixing the chip to a pickup unit, and separating the chip from the tape by moving the pickup unit.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view of a chip ejector according to an embodiment of the present invention;

FIG. 2 is a plan view of a fixing unit of the chip ejector according to the embodiment of the present invention;

FIG. 3 is a cross-sectional view of a conveying unit of the chip ejector according to the embodiment of the present invention while falling;

FIG. 4 is a cross-sectional view of the conveying unit of the chip ejector according to the embodiment of the present invention while falling;

FIG. 5 is a cross-sectional view of the conveying unit of the chip ejector according to the embodiment of the present invention while falling;

FIG. 6 is a cross-sectional view of the conveying unit of the chip ejector according to the embodiment of the present invention while falling;

FIG. 7 is a cross-sectional view of the conveying unit of the chip ejector according to the embodiment of the present invention while falling;

FIG. 8 is a cross-sectional view of a chip ejector according to another embodiment of the present invention;

FIG. 9 is a cross-sectional view of a conveying unit of the chip ejector according to another embodiment of the present invention while falling;

FIG. 10 is a cross-sectional view of the conveying unit of the chip ejector according to another embodiment of the present invention while falling;

FIG. 11 is a cross-sectional view of the conveying unit of the chip ejector according to another embodiment of the present invention while falling;

FIG. 12 is a cross-sectional view of the conveying unit of the chip ejector according to another embodiment of the present invention while falling; and

FIG. 13 is a cross-sectional view of the conveying unit of the chip ejector according to another embodiment of the present invention while falling.

### DETAILED DESCRIPTION OF THE EMBODIMENTS

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like elements.

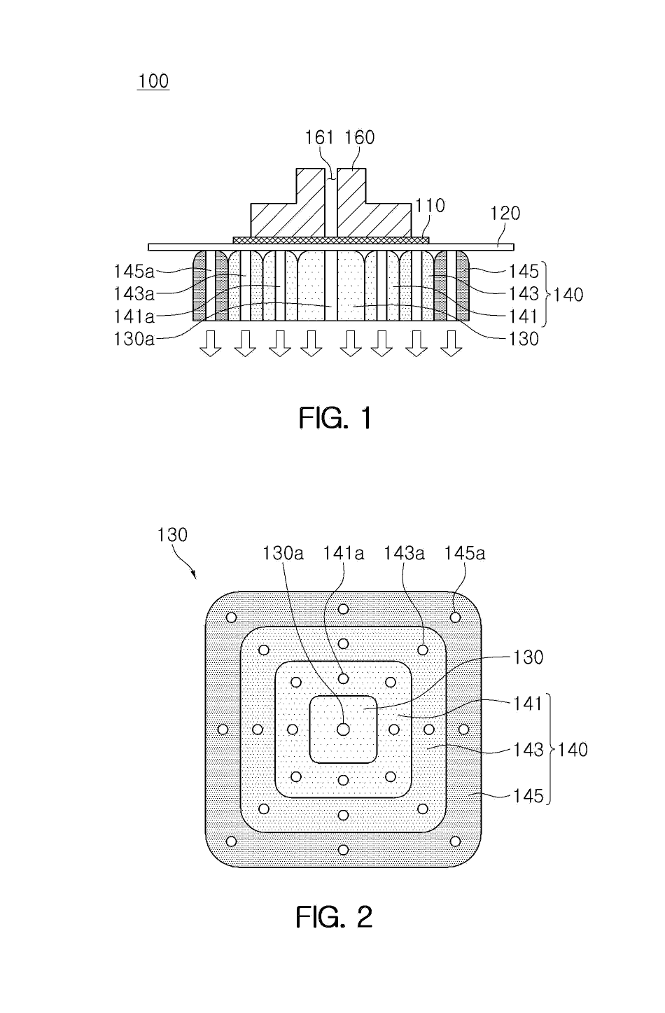

FIG. 1 is a cross-sectional view of a chip ejector according to an embodiment of the present invention. FIG. 2 is a plan view of a fixing unit of the chip ejector according to the embodiment of the present invention.

Referring to FIGS. 1 to 3, a chip ejector 100 according to an embodiment of the present invention includes a fixing unit 130, a conveying unit 140, and a pickup unit 160, and a conveying unit actuator 170.

A tape 120, to which a chip 110 is attached may be disposed on one surface of the fixing unit 130. One surface of the fixing unit 130 may be formed to be flat such that the tape 120 may be attached to one surface thereof.

A cross section of the fixing unit 130 may be rectangular, but is not limited thereto and as long as the tape 120 may be attached to one surface, any shape may be used. The present invention is not limited in terms of a cross-sectional shape of the fixing unit 130.

At least one through hole 130a may be formed in the center of the fixing unit 130 such that it passes through an upper side and a lower side thereof.

Although FIGS. 1 and 2 show that one through hole 130a is formed in the fixing unit 130, a plurality of through holes 130a can be formed therein.

In a final step of separating the chip 110 from the tape 120, the tape 120 is pushed upwards by air being sprayed upwardly through the through hole 130a so that the chip 110 may be separated from the tape 120.

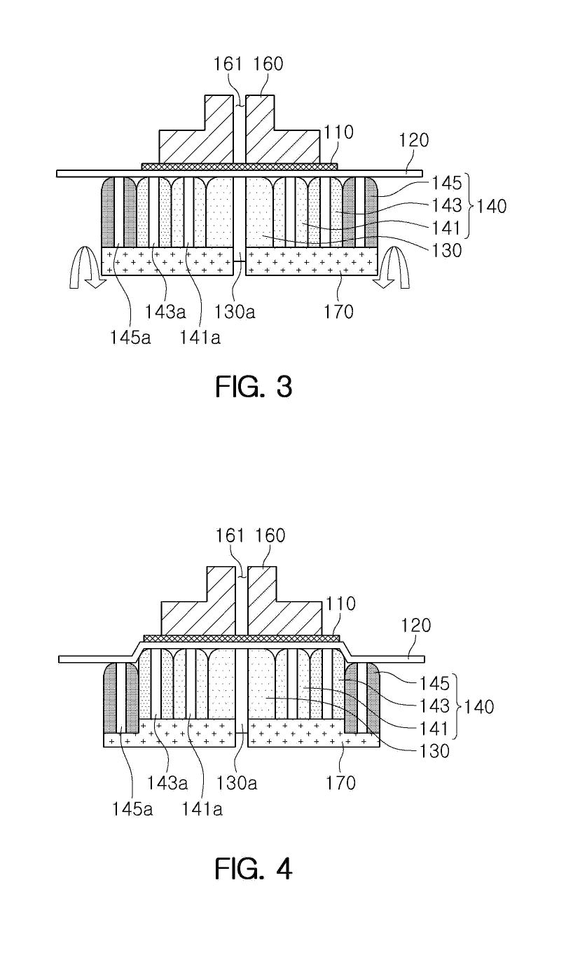

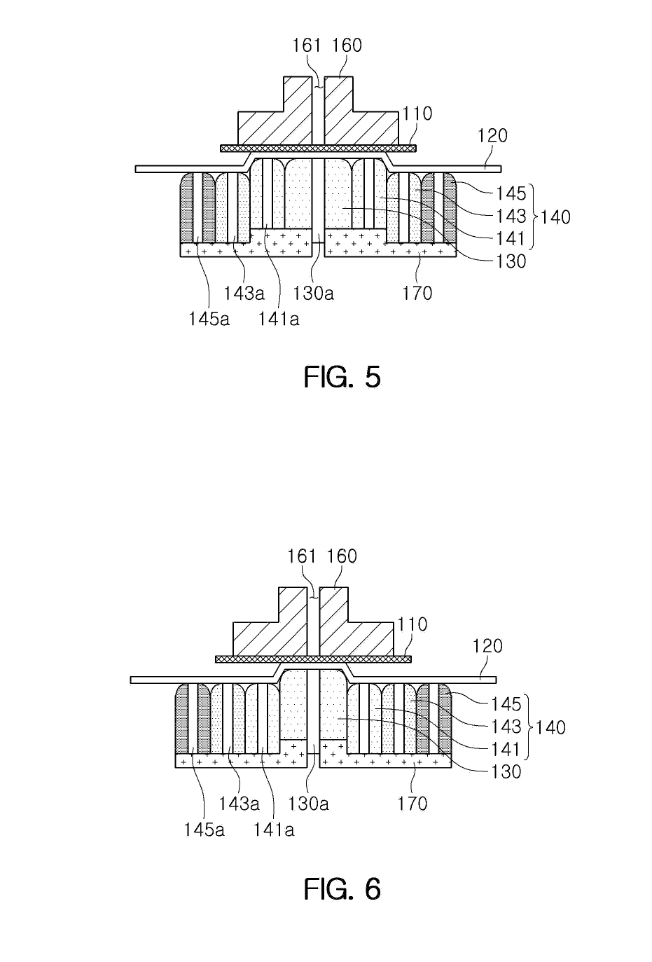

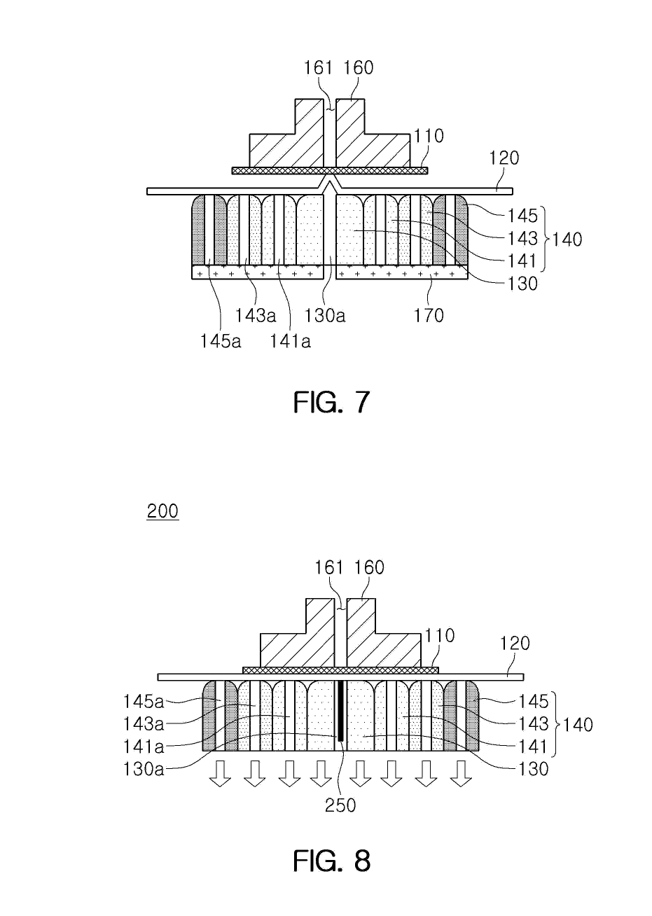

A process of separating the chip 110 from the tape 120 by the chip ejector 100 according to the embodiment of the present invention will be described later with reference to FIGS. 3 through 8.

The conveying unit 140 may be disposed outwardly of the fixing unit 130. The tape 120 may be disposed on one surface of the conveying unit 140.

That is, the tape 120 may be disposed on one surface of the fixing unit 130 and one surface of the conveying unit 140.

One surface of the conveying unit 140 may be formed to be flat such that the tape 120 may be attached to one surface of the conveying unit 140. One surface of the fixing unit 130 and one surface of the conveying unit 140 may be disposed on the same plane.

The conveying unit 140 may include a plurality of conveying units. Although FIGS. 1 and 2 show that the conveying unit 140 is formed of three conveying units 141, 143, and 145, the number of conveying units is not limited thereto, provided that the conveying unit 140 is formed of a plurality of conveying units.

At least one or more through holes 141a, 143a, and 145a that pass through an upper side and a lower side thereof may be formed in the conveying units.

Air may be drawn through the through holes 141a, 143a, and 145a such that the tape 120 may be adhered and fixed to one surface of the fixing unit 130 and one surface of the conveying unit 140.

Diameters of the through holes 130a, 141a, 143a, and 145a formed in the fixing unit 130 and the conveying unit 140 may be formed such that the tape 120 cannot be drawn into the through holes 130a, 141a, 143a, and 145a.

Therefore, even in the case that air is drawn through the through holes 141a, 143a, and 145a, the tape 120 may not be drawn into the through holes 141a, 143a, and 145a, and may be adhered and fixed to one surface of the fixing unit 130 and one surface of the conveying unit 140.

The conveying unit 140 may be formed to fall or rise due to the conveying unit actuator 170. The conveying unit actuator 170 may use a general means such as a rod type cam or cylinder.

More specifically, elastic force may be provided to the conveying unit 140 by installing an elastic member on a lower side of the conveying unit 140, and the individual conveying units of the conveying unit 140 may sequentially fall or rise by rotating the rod type cam.

The individual conveying units of the conveying unit 140 may sequentially fall by a predetermined distance. In the chip ejector 100 according to the embodiment of the present invention, the individual conveying units of the conveying unit 140 may fall sequentially inwardly from the outside thereof.

When the individual conveying units of the conveying unit 140 sequentially fall inwardly from the outside in a state where the tape 120 is adhered and fixed to one surface of the fixing unit 130 and one surface of the conveying unit 140, the tape 120 adhered and fixed to the conveying unit 140 may also fall along with the conveying unit 140.

Therefore, the chip 110 may be sequentially separated from the tape 120.

Even in the case that the conveying unit 140 falls and the tape 120 adhered and fixed to one surface of the conveying unit 140 is separated from the chip 110, the chip 110 is still attached to the tape 120 attached to one surface of the fixing unit 130.

In this regard, the tape 120 may be pushed upwards by air being sprayed upwardly through the through hole 130a formed in the fixing unit 130.

The tape 120 is pushed upwards and thus a part of the chip 110 attached to the tape 120 is further reduced, thereby minimizing the part of the chip 110 attached to the tape 120.

The pickup unit 160 may be disposed in upper sides of the fixing unit 130 and the conveying unit 140.

Although FIG. 1 shows that the pickup unit 160 is disposed to contact the chip 110 attached to the tape 120, the pickup unit 160 may be disposed in upper sides of the fixing unit 130 and the conveying unit 140 in a state where the pickup unit 160 does not contact the chip 110.

After the conveying unit 140 falls and the part of the chip 110 attached to the tape 120 is minimized by air being sprayed upwardly through the through hole 130a formed in the fixing unit 130 and pushing the tape 120 upwards, the chip 110 may be completely separated from the tape 120 by allowing the pickup unit 160 to pick the chip 110 up.

More specifically, a through hole 161 that passes through an upper side and a lower side of the pickup unit 160 may be formed in the center of the pickup unit 160. Air may be drawn through the through hole 161.

Therefore, the chip 110 may be adhered by the pickup unit 160 and may be completely separated from the tape 120 by moving the pickup unit 160.

FIGS. 3 through 7 are cross-sectional views of the conveying units of the chip ejector that sequentially fall inwardly from the outside thereof according to another embodiment of the present invention.

A process of separating the chip 110 from the tape 120 by using the chip ejector 100 according to the embodiment of the present invention will now be described below with reference to FIGS. 3 through 7.

As shown in FIG. 3, the tape 120 to which the chip 110 is attached is mounted in one surface of the fixing unit 130 and one surface of the conveying unit 140 disposed outwardly of the fixing unit 130.

Air is drawn through the through holes 141a, 143a, and 145a formed in the conveying unit 140 such that the tape 120 may be adhered and fixed to one surface of the fixing unit 130 and one surface of the conveying unit 140.

The individual conveying units of the conveying unit 140 sequentially fall in a state where the tape 120 is adhered and fixed to one surface of the fixing unit 130 and one surface of the conveying unit 140.

In this regard, the individual conveying units of the conveying unit 140 may fall sequentially inwardly from the outside thereof, and, to the contrary, may sequentially fall outwardly from the inside thereof.

As the conveying unit 140 falls, the tape 120 adhered and fixed to the conveying unit 140 may also fall along with the conveying unit 140, and thus the chip 110 may be sequentially separated from the tape 120.

After the conveying unit 140 completely falls, air is sprayed upwardly through the through hole 130a formed in the fixing unit 130 or a pin (not shown) installed inside the through hole 130a rises to protrude outwardly from the fixing unit 130, and thus the tape 120 adhered and fixed to the fixing unit 130 may be pushed upwards.

Therefore, a part of the chip 110 attached to the tape 120 may be minimized.

Finally, the chip 110 is adhered and fixed to the pickup unit 160 by drawing air through the through hole 161 formed in the pickup unit 160.

The chip 110 is completely separated from the tape 120 in the case in which the pickup unit 160 moves in a state where the chip 110 is adhered and fixed to the pickup unit 160.

The part of the chip 110 attached to the tape 120 is minimized due to actions of the conveying unit 140 and the fixing unit 130, thereby separating the chip 110 from the tape 120 without damaging to the chip 110.

In this regard, the conveying unit 140 that has fallen may rise to the original location, and another tape to which a chip is attached may be disposed on the fixing unit 130 and the conveying unit 140 and thus the above process may be repeatedly performed.

The chip ejector 100 according to the embodiment of the present invention may minimize damages to the chip 110, since the tape 120 is adhered and fixed to the individual conveying units of the conveying unit 140 and the conveying units and the tape 120 sequentially fall together so that the chip 110 is separated from the tape 120.

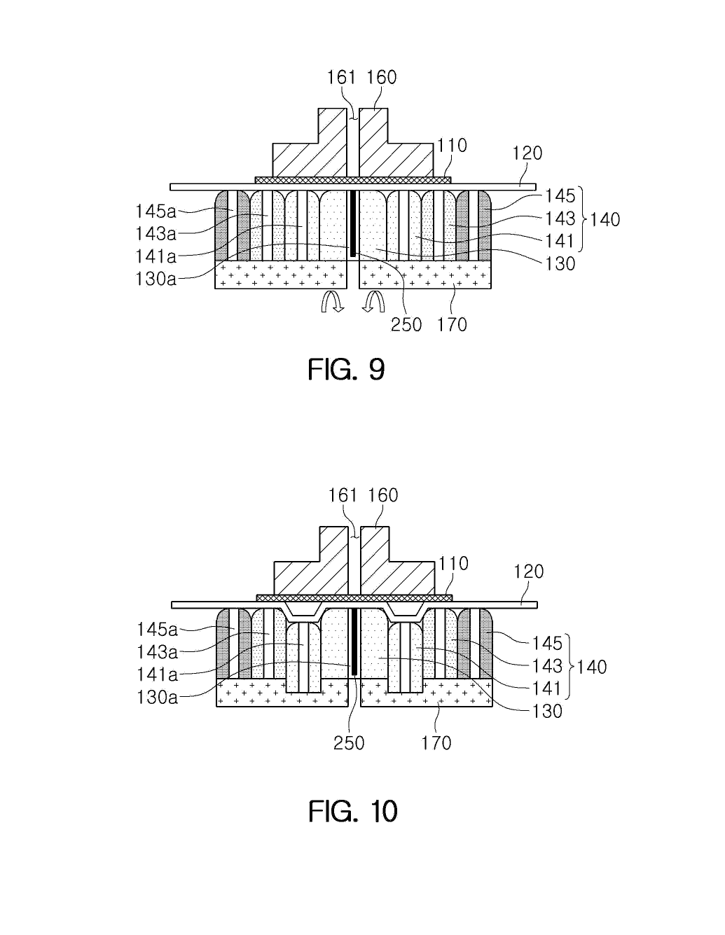

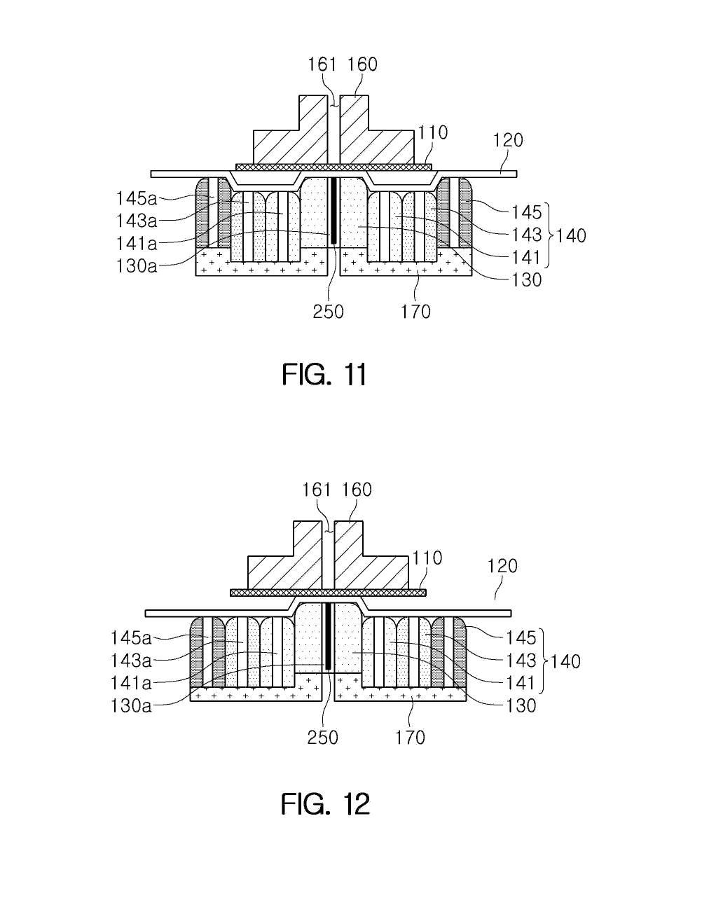

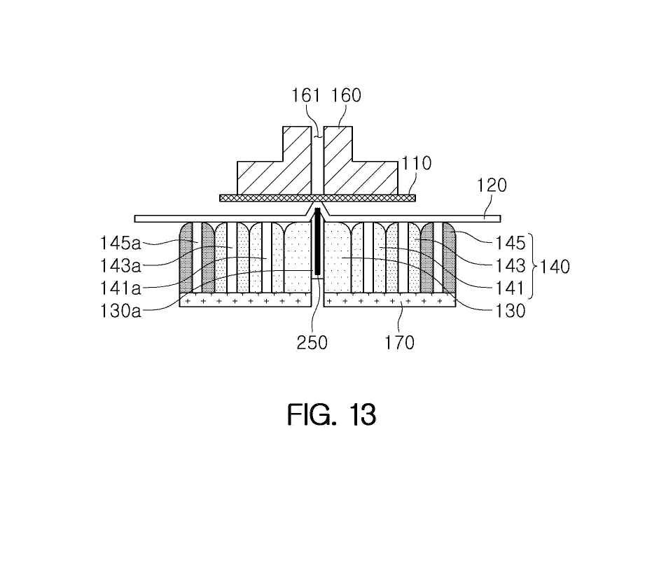

FIG. 8 is a cross-sectional view of a chip ejector according to another embodiment of the present invention. FIGS. 9 through 13 are cross-sectional views of conveying units of the chip ejector that sequentially fall outwardly from the inside thereof according to another embodiment of the present invention.

Referring to FIG. 8, a chip ejector 200 according to another embodiment of the present invention is the same as the chip ejector 100 according to the embodiment of the present invention, excepting the conveying unit 140 and the pin 250, and thus a detailed description thereof will be omitted.

The conveying unit 140 may be formed of a plurality of conveying units. The number of conveying units is not limited provided that the conveying unit 140 is formed of a plurality of conveying units.

The individual conveying units of the conveying unit 140 may sequentially fall by a predetermined distance. The individual conveying units of the conveying unit 140 may sequentially fall outwardly from the inside thereof in the chip ejector 200 according to another embodiment of the present invention.

When the individual conveying units of the conveying unit 140 sequentially fall outwardly from the inside thereof in a state where the tape 120 is adhered and fixed to one surface of the fixing unit 130 and one surface of the conveying unit 140, the tape 120 adhered and fixed to the conveying unit 140 may also fall along with the conveying unit 140.

Therefore, the chip 110 may be sequentially separated from the tape 120.

Even in the case that the conveying unit 140 falls and the tape 120 adhered and fixed to one surface of the conveying unit 140 is separated from the chip 110, the chip 110 is still attached to the tape 120 attached to one surface of the fixing unit 130.

In this regard, like the chip ejector 100 according to the above-described embodiment of the present invention, the tape 120 may be pushed upwards by air being sprayed upwardly through the through hole 130a formed in the fixing unit 130. Alternatively, the tape 120 may be pushed upwards by using the pin 250 installed in the through hole 130a.

The tape 120 is pushed upwards and thus a part of the chip 110 attached to the tape 120 is further reduced, thereby minimizing the part of the chip 110 attached to the tape 120.

Unlike the chip ejector 100 according to the above-described embodiment of the present invention, the pin 250 may be installed in the through hole 130a formed in the fixing unit 130 of the chip ejector 200 according to this embodiment of the present invention.

The pin 250 may be installed in the through hole 130a. In a final step of separating the chip 110 from the tape 120, the tape 120 is pushed upwards by raising the pin 250 such that the pin 250 may protrude outwardly from the fixing unit 130, thereby separating the chip 110 from the tape 120.

Even in the case that the conveying unit 140 falls and the tape 120 adhered and fixed to one surface of the conveying unit 140 is separated from the chip 110, the chip 110 is still attached to the tape 120 attached to one surface of the fixing unit 130.

In this regard, the tape 120 may be pushed upwards by raising the pin 250 attached to the through hole 130a formed in the fixing unit 130 in the chip ejector 200 according to this embodiment of the present invention.

More specifically, as the pin 250 rises such that the pin 250 protrudes outwardly from the fixing unit 130, the tape 120 contacting the pin 250 is pushed upwards, and thus the chip 110 is separated from the tape 120.

Air is drawn through the through hole 161 formed in the pickup unit 160, and thus the chip 110 may be adhered by the pickup unit 160 and move, thereby completely separating the chip 110 from the tape 120.

According to the embodiments described above, a chip ejector according to the present invention may have an effect of minimizing damages to the chip 110 and stably separating the chip 110 from the tape 120.

As set forth above, in a chip ejector and a chip removal method according to embodiments of the present invention, cost loss due to a defective chip can be suppressed, and a chip can be separated from a tape stably by suppressing damages to the chip such as cracks and breakdowns during a chip removal process.

While the present invention has been shown and described in connection with the embodiments, it will be apparent to those skilled in the art that modifications and variations can be made without departing from the spirit and scope of the invention as defined by the appended claims.

What is claimed is:

1. A chip ejector comprising:
a fixing unit; and
at least one or more conveying units disposed outwardly of the fixing unit,
wherein the conveying units fall with a tape having one surface attached to upper portions of the conveying units, and separate a chip attached to the other surface of the tape therefrom.

2. The chip ejector of claim 1, wherein the individual conveying units fall sequentially.

3. The chip ejector of claim 2, wherein the individual conveying units sequentially fall inwardly from the outside thereof.

4. The chip ejector of claim 2, wherein the individual conveying units sequentially fall outwardly from the inside thereof.

5. The chip ejector of claim 1, wherein the fixing unit and the conveying units have a through hole that passes through an upper side and a lower side thereof.

6. The chip ejector of claim 5, wherein the through hole formed in the fixing unit has at least one pin installed therein.

7. The chip ejector of claim 5, wherein air is drawn through the through hole such that the tape is adhered and fixed to the conveying units.

8. The chip ejector of claim 1, further comprising a pickup unit picking up the chip separated from the tape.

9. The chip ejector of claim 1, further comprising a conveying unit actuator transferring power to the conveying units.

10. A chip removal method comprising:
mounting a tape to which a chip is attached on one surface of a fixing unit and one surface of at least one or more conveying units disposed outwardly of the fixing unit;
adhering and fixing the tape to one surface of the fixing unit and one surface of the conveying units by drawing air through through holes formed in the fixing unit and the conveying units; and
controlling the individual conveying units to fall sequentially.

11. The chip removal method of claim 10, wherein the individual conveying units sequentially fall inwardly from the outside thereof.

12. The chip removal method of claim 10, wherein the individual conveying units sequentially fall outwardly from the inside thereof.

13. The chip removal method of claim 10, further comprising pushing the tape to which the chip is attached upwards by raising a pin installed in the through hole formed in the fixing unit such that the pin protrudes outwardly from the fixing unit.

14. The chip removal method of claim 10, further comprising pushing the tape to which the chip is attached upwards by spraying air through the through hole formed in the fixing unit.

15. The chip removal method of claim 10, further comprising:
adhering and fixing the chip to a pickup unit; and
separating the chip from the tape by moving the pickup unit.
